(19) United States
(12) Patent Application Publication
(10) Pub. No.: US 2008/0096723 A1
(43) Pub. Date: Apr. 24, 2008

(54) Electrical gym chair

(76) Inventor: Li-Hsia Chang, Fengyuan City (TW)

Correspondence Address: Hershkovitz & Associates, LLC, 2845 Duke Street, Alexandria, VA, 22314, US

(21) Appl. No.: 11/585,162

(22) Filed: Oct. 24, 2006

(51) Int. Cl. A63B 15/02; A61H 1/02; A63B 71/00

(52) U.S. Cl. 482/1; 601/23

(57) ABSTRACT

An electric gym chair has a support, a motor connecting to the support, an eccentric ring assembly pivotally provided on a top end of the support and driven by the motor, a seat mounted securely on the eccentric ring assembly and a cushion attached to the eccentric ring assembly. When the motor is operated, the eccentric ring assembly is rotated to move the cushion a circular track to fully exercise the waist of the user.

### BACKGROUND OF THE INVENTION

1. Field of the Invention

The present invention relates to an electrical gym chair, and more particularly to an electrical gym chair that is used to exercise.

2. Description of the Related Art

A conventional electrical gym appliance has a plate and a motor. An eccentric wheel is mounted in the motor, and a post is connected between the eccentric wheel and the plate and drives the plate to vibrate. The user stands on the plate and gets exercise of the lower half body by being shaken.

The conventional electrical gym appliance can only exercise the user's lower body. However, the excess fat is usually accumulates around the waist that is not easily exercised by the conventional electrical gym appliance. Therefore, the conventional gym appliance cannot provide sufficiently exercising effect.

Therefore, the invention provides an electrical gym chair to mitigate or obviate the aforementioned problems.

### SUMMARY OF THE INVENTION

The main objective of the present invention is to provide an electrical gym chair that provides fully exercise for the user.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first preferred embodiment of an electrical gym chair in accordance with the present invention;

FIG. 2 is an exploded perspective view of the first preferred embodiment of the electrical gym chair in FIG. 1;

FIG. 3 is a partially perspective view of the first preferred embodiment of the electrical gym chair in FIG. 1;

FIG. 4 is an operational perspective view of the first preferred embodiment of the electrical gym chair in FIG. 1;

FIG. 5 is a partially perspective view of a second preferred embodiment of an electrical gym chair in accordance with the present invention; and

FIG. 6 is an exploded perspective view of a third preferred embodiment of an electrical gym chair in accordance with the present invention.

### DETAILED DESCRIPTION OF THE PREFERRED EMBODIMENT

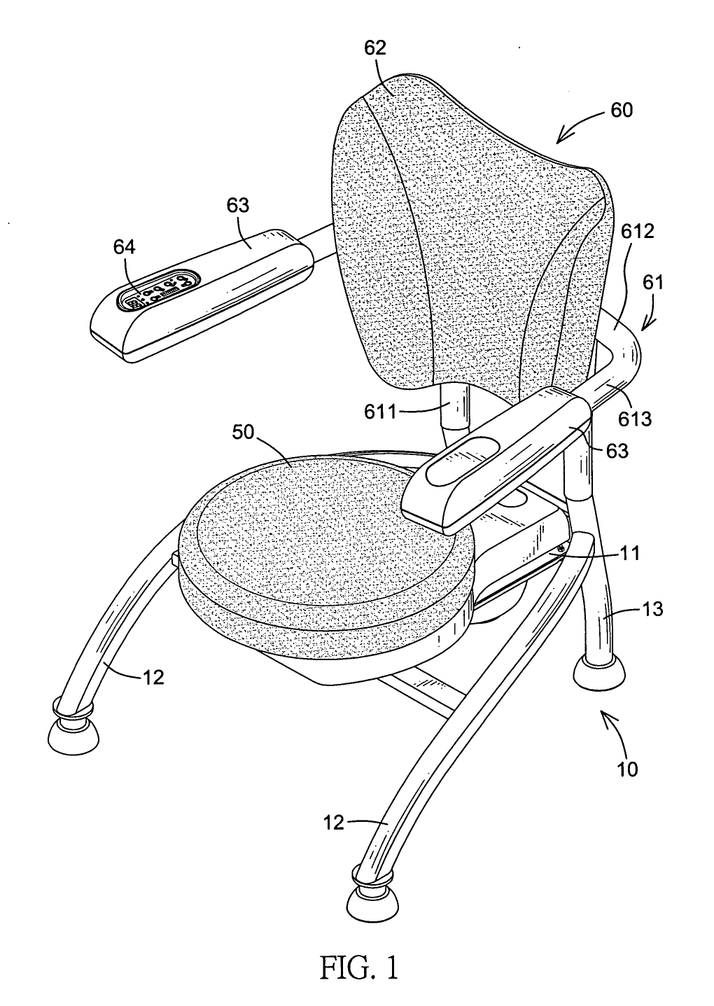

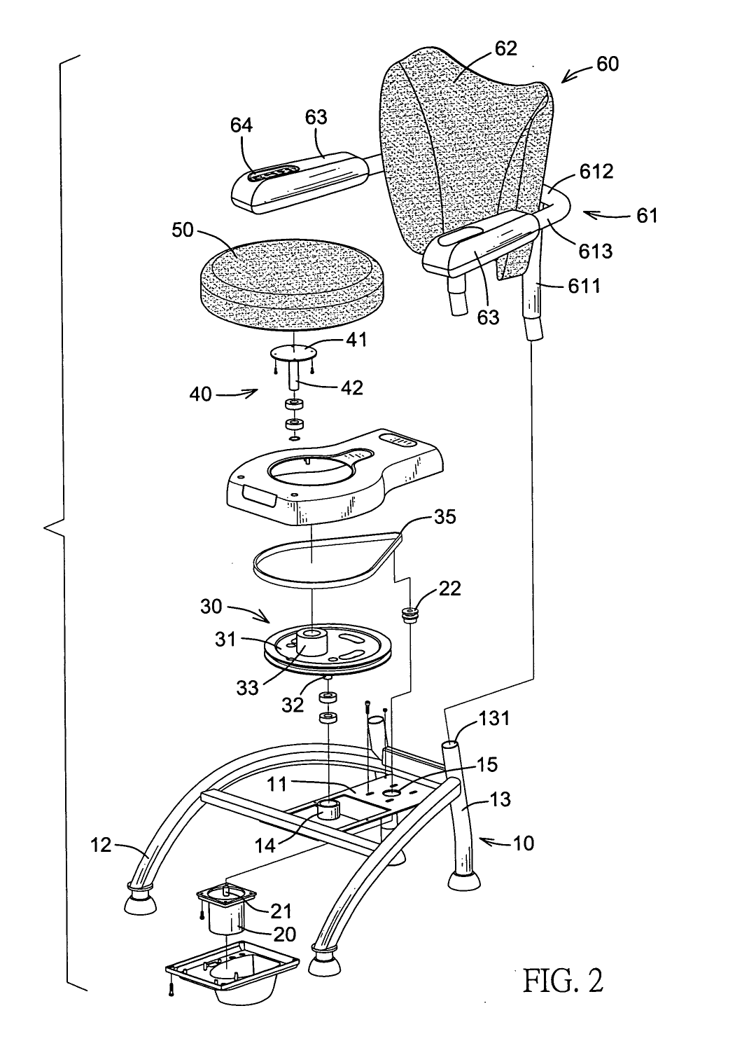

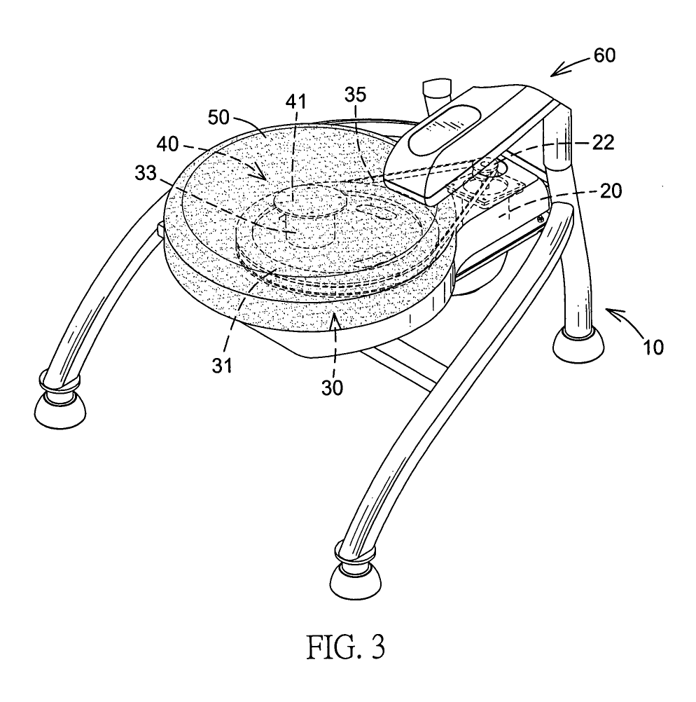

With reference to FIGS. 1 to 3, an electrical gym chair in accordance with the present invention has a support (10), a motor (20), an eccentric ring assembly (30), a seat (40), a cushion (50), and a rest member (60).

The support (10) has a central bracket (11), two front feet (12), two rear feet (13) and a first pivotal holder (14). The front feet (12) and the rear feet (13) are formed respectively on four corners of the central bracket (11). Two holes (131) are respectively and axially defined in the rear feet (12). The first pivotal holder (14) is formed on the central bracket (11) near the front end. A circular hole (15) is defined through the central bracket (11) near the rear end.

The motor (20) connects to the support (10), is mounted under the central bracket (11) and engages with the circular hole (15). The motor (20) has an axle (21) and a driving wheel (22). The axle (21) extends out of the motor (20), extends through the circular hole (15) and connects to the driving wheel (22). The driving wheel (22) connects to the axle (21).

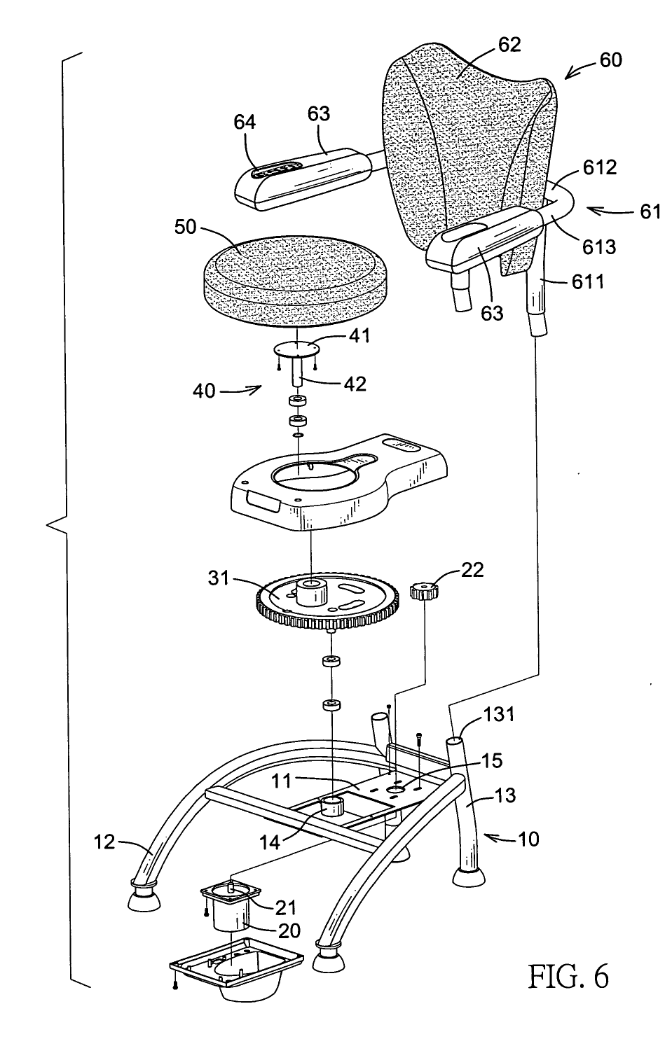

With further reference to FIG. 6, the eccentric ring assembly (30) is provided rotatably on the support (10) and has an eccentric wheel (31), a shaft (32), and a second pivotal holder (33). The eccentric wheel (31) has a diameter larger than a diameter of the driving wheel (22). The shaft (32) is formed on a center of a bottom surface of the eccentric wheel (31) and connects rotatably to the first pivotal holder (14). The second pivotal holder (33) is formed eccentrically on a top surface of the eccentric wheel (31). The eccentric wheel (31) and the driving wheel (22) may both be belt pulleys or gears. When the eccentric wheel (31) and the driving wheel (22) are belt pulleys, a driving belt (35) is mounted around the eccentric wheel (31) and the driving wheel (22). When the eccentric wheel (3 1) and the driving wheel (22) are gears, the eccentric wheel (31) engages the driving wheel (22).

The seat (40) is mounted securely on the eccentric ring assembly (30) and has a disk (41) and a post (42). The disk (41) is mounted on the eccentric ring assembly (30). The post (42) is formed axially on the bottom surface of the disk (41). A lower end of the post (42) is mounted securely in the second pivotal holder (33).

The cushion (50) is secured onto the disk (40) with fasteners.

The rest member (60) is mounted securely on the support (10) and has a rest bracket (61), a backrest (62), an armrest (63) and a controller (64). The rest bracket (61) is mounted securely on the rear feet (13) of the support (10) and has two bars (611) away from each other and a U-shaped tube (612). The bars (611) are inserted into the holes (131) in the rear feet (13). A middle portion of the U-shaped tube (612) connects to top ends of the bars (611). Two extending rods (613) are formed respectively on two ends of the U-shaped tube (612). The backrest (62) connects to the fronts of the bars (611) and the middle portion of the U-shaped tube (612). The armrests (63) respectively connect to the extending rods (613). The controller (64) is attached to one of the armrests (63) and electrically connects to the motor (20) to control the motor (20).

In the first preferred embodiment of the present invention, the cushion (50) can be sat by the user and the rest member (60) can give a supporting effect to the user.

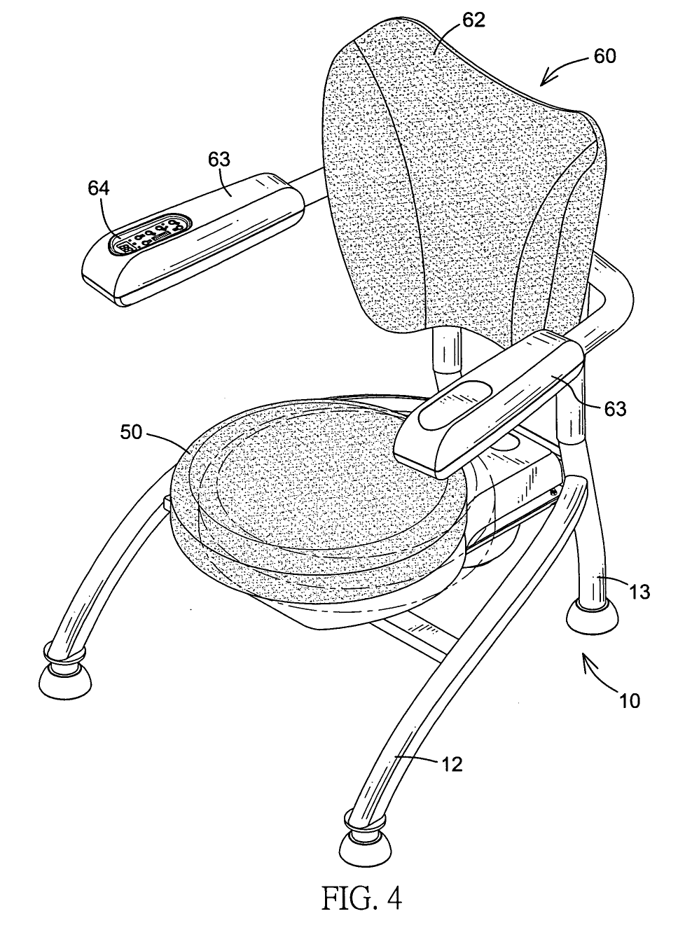

With further reference to FIG. 4, when the controller (64) starts the motor (20), the eccentric ring assembly (30) can be rotated by the driving wheel (22) so that the second pivotal holder (33) can move in a circular track to generate a centrifugal force. The cushion (50) can be moved in a circular track to fully exercise the waist of the user.

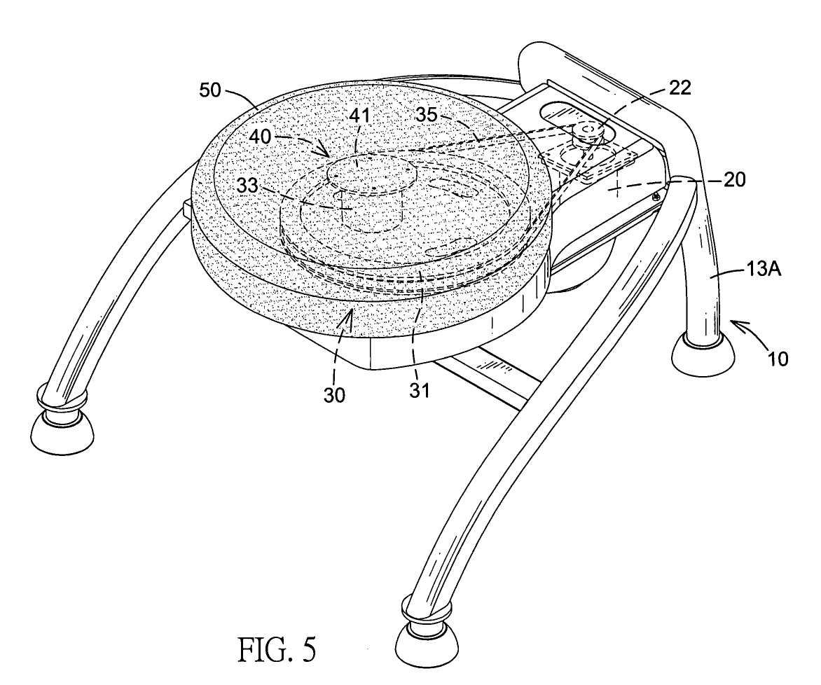

With further reference to FIG. 5, a second preferred embodiment of the present invention is similar to the first preferred embodiment but has no backrest and the rear feet (13A) is U-shaped.

It is to be understood, however, that even though numerous characteristics and advantages of the present invention have been set forth in the foregoing description, together with details of the structure and function of the invention, the disclosure is illustrative only. Changes may be made in details, especially in matters of shape, size, and arrangement of parts within the principles of the invention to the full extent indicated by the broad general meaning of the terms in which the appended claims are expressed.

What is claimed is:

1. An electric gym chair comprising:
a support,
a motor connecting to the support,
an eccentric ring assembly rotatably provided on the support and driven by the motor,
a seat mounted securely and eccentrically on the eccentric ring assembly and having a disk, and
a cushion attached to the disk.

2. The electric gym chair as claimed in claim 1, wherein
the support has
a central bracket;
two front feet and two rear feet formed respectively on four corners of the central bracket;
a first pivotal holder formed on the central bracket near a front end of the central bracket; and
a circular hole defined through the central bracket near a rear end of the central bracket;
the motor has
a driving wheel being a belt pulley; and
an axle extending out of the motor, extending through the circular hole in the central bracket of the support and connecting to the driving wheel;
the eccentric ring assembly has
an eccentric wheel being a belt pulley and having a diameter larger than a diameter of the driving wheel; and
a shaft formed on a center of a bottom surface of the eccentric wheel and connecting rotatably to the first pivotal holder; and
a driving belt is mounted around the driving wheel and the eccentric wheel.

3. The electric gym chair as claimed in claim 2, wherein
the eccentric wheel assembly has a second pivotal holder formed eccentrically on a top surface of the eccentric wheel; and
the seat has a post formed axially on a bottom surface of the disk of the seat and having a lower end mounted securely on the second pivotal holder.

4. The electric gym chair as claimed in claim 2, wherein the rest member further comprises
a rest bracket mounted securely on the rear feet of the support and having
two bars inserted respectively into the holes in the rear feet and each having a top end and a front; and
a U-shaped tube having
a middle portion connecting to the top ends of the bars; and
two extending rods formed respectively on two ends of the U-shaped tube;
a backrest connecting to the fronts of the bars of the rest bracket and the middle portion of the U-shaped tube; and
two armrests respectively connecting to the extending rods.

5. The electric gym chair as claimed in claim 4, wherein the seat further comprises a controller attached to one of the armrests and electrically connecting to the motor.

6. The electric gym chair as claimed in claim 1, wherein
the support has
a central bracket;
two front feet and two rear feet formed respectively on four corners of the central bracket;
a first pivotal holder formed on the central bracket near a front end of the central bracket; and
a circular hole defined through the central bracket near a rear end of the central bracket;
the motor has
a driving wheel being a gear; and
an axle extending upright out of the motor, extending through the circular hole in the central bracket of the support and connecting to the driving wheel; and
the eccentric ring assembly has
an eccentric wheel being a gear, engaging the driving wheel and having a diameter larger than a diameter of the driving wheel; and
a shaft formed on a center of a bottom surface of the eccentric wheel and connecting rotatably to the first pivotal holder.
